(19) United States
(12) Patent Application Publication
(10) Pub. No.: US 2002/0090731 A1
(43) Pub. Date: Jul. 11, 2002

(54) Method for treating objects

(76) Inventors: Robert Gropp, Schifferstadt (DE); Stefan Kuenkel, Karlsruhe (DE)

Correspondence Address: Simpson, Simpson & Snyder, PLLC, 5555 Main Street, Williamsville, NY, 14221, US

(21) Appl. No.: 10/011,510

(22) Filed: Oct. 22, 2001

(30) Foreign Application Priority Data
Oct. 24, 2000 (DE) 100 52 834.1

(51) Int. Cl. G01N 35/00

(52) U.S. Cl. 436/48; 422/65; 422/67

(57) ABSTRACT

A method for treating objects, in particular cytological or histological specimens, for example in an automatic stainer, the objects being delivered, preferably on object carriers and in object carrier magazines, by means of a transport device to various processing stations, inserted therein, and treated in accordance with a selectable or a definable or programmable treatment program, is characterized by unequivocal allocation of the object carriers or object carrier magazines, or clips or labeling fields to be attached thereon, to specific treatment programs.

### CROSS REFERENCE TO RELATED APPLICATIONS

This invention claims priority of the German patent application 100 52 834.1 filed Oct. 24, 2000 which is incorporated by reference herein.

### FIELD OF THE INVENTION

The present invention concerns a method for treating objects, in particular cytological or histological specimens, for example in an automatic stainer, the objects being delivered, preferably on object carriers and in object carrier magazines, by means of a transport device to various processing stations, inserted therein, and treated in accordance with a selectable or a definable or programmable treatment program.

### BACKGROUND OF THE INVENTION

The reader is referred, merely by way of example, to EP 0 849 582 A1. This document discloses a generic method for treating objects, in particular cytological or histological specimens. In it, cytological or histological specimens are conveyed, by means of an object carrier or basket and optionally in magazines, to the variously operating treatment stations of an automatic stainer, the stainer comprising multiple processing stations having different reagents.

The generic method known from EP 0 849 582 A1 makes provision for various staining programs, but furnishes no user-friendly overview of the available staining programs and their program sequence.

### SUMMARY OF THE INVENTION

It is thus the object of the present invention to configure and further develop a method for treating objects, in particular cytological or histological specimens, in such a way as to make possible a simple user interface that imparts the individual processing steps and processing stations of selectable programs.

The aforesaid object is achieved improving a generic method for treating objects, in particular cytological and histological specimens, by an unequivocally allocating the object carriers or object carrier magazines, and clips or labeling fields to be attached thereon, to specific treatment programs. What has been recognized according to the present invention is that a user interface as well as documentation of the individual processing steps and processing stations of the respective processing programs is possible only if there exists an unequivocal allocation of the object carriers or object carrier magazines, or the clips, labeling fields or the like to be attached thereon, to a specific treatment program. An allocation of this kind ultimately makes it possible to recognize which specific treatment stations are being addressed by which program in which sequence. The allocation in this context is unequivocal.

An allocation of the kind according to the present invention could be accomplished by marking the object carriers or object carrier magazines, or the clips or labeling fields to be attached thereon, by visual perception. Specifically relevant as markings are numbers, words, names, or other brief designations that are immediately recognizable and above all can be depicted in two dimensions. The depiction must also, in particular, be suitable for presentation on a display.

Also possible as markings are colors or color codes that, because of the enormous differentiation capability of the human eye, can be used in very particularly advantageous fashion. If, for example, three to six different processing programs and/or, for example, up to eight different colors are available, these can easily be identified by the primary colors plus mixed colors, thereby ruling out any confusion. Colors, color codes, and the arrangement of multicolored codes are suitable in principle as markings. Since colors are difficult to differentiate in particular for the identification of numerous processing programs, above a certain number of programs it is very particularly advantageous to use multicolored codes.

In additionally advantageous fashion, the user interface is accomplished by way of a display symbolizing the processing programs and optionally the processing stations. The processing stations could be presented on the display in a manner similar to their physical arrangement and in accordance with how they are loaded with reagents in the unit.

After loading of the processing stations (for example with reagents) by the user, definition of the processing stations thus loaded, and selection or programming of a processing program with activation of various processing stations, all of the executable processing programs are automatically ascertained and shown on the display. As a result of the marking provided, for example, as color coding, it is possible to recognize unequivocally, for each processing program, the processing steps and processing stations pertaining to it. Note in this context that it is not absolutely necessary to allocate the processing stations directly to a program on the basis of a color marking. In the context of, for example, eight different programs, this would result in a very poorly organized color presentation. A corresponding allocation is possible in principle, however, especially when not too many processing stations are provided.

In additionally advantageous fashion, the execution sequence of the individual processing programs is evident from the display by allocation of the program-specific coding, along with the numbering symbolizing the processing sequence, to the graphically symbolized processing stations. A corresponding numbering of the stations in the graphical overview on the display is not, however, absolutely necessary, and could be selectably switched in or out. The color coding thus makes evident the processing stations belonging to a specific processing program, their positions in the unit, and (on the basis of the numbering provided) the sequence of processing. During processing it is possible for the processing station currently in process to be indicated (also visually).

It is furthermore possible for additional unit-specific and/or processing-specific information to be ascertained and indicated on the display. Relevant additional information includes, for example, the loading state of an unloading station, the time until the unloading station is completely filled up as processing proceeds and removal is required as a result thereof, and/or the time of the next processing of an object carrier or object carrier magazine. A symbolic indication on the display is possible. With regard to the features just cited, be it noted that a unit could comprise only a single unloading station. The time until removal is required would then be identical to the “loading time.” If, however, an unloading apparatus in the unit advantageously comprises several unloading stations, the indicated time until removal is required depends on when all the available unloading stations are full or occupied, the reason being that the robot arm in the unit then has no further opportunities to set down additional racks. Both time indications—time until a single unloading station is loaded or time until all unloading stations are loaded—can be used as parameters, and can also be presented graphically and/or numerically on the display.

### BRIEF DESCRIPTION OF THE DRAWING

In the drawing:

FIG. 1 shows of a visual indication of the individual processing stations on a display in accordance with an exemplary embodiment of the present invention.

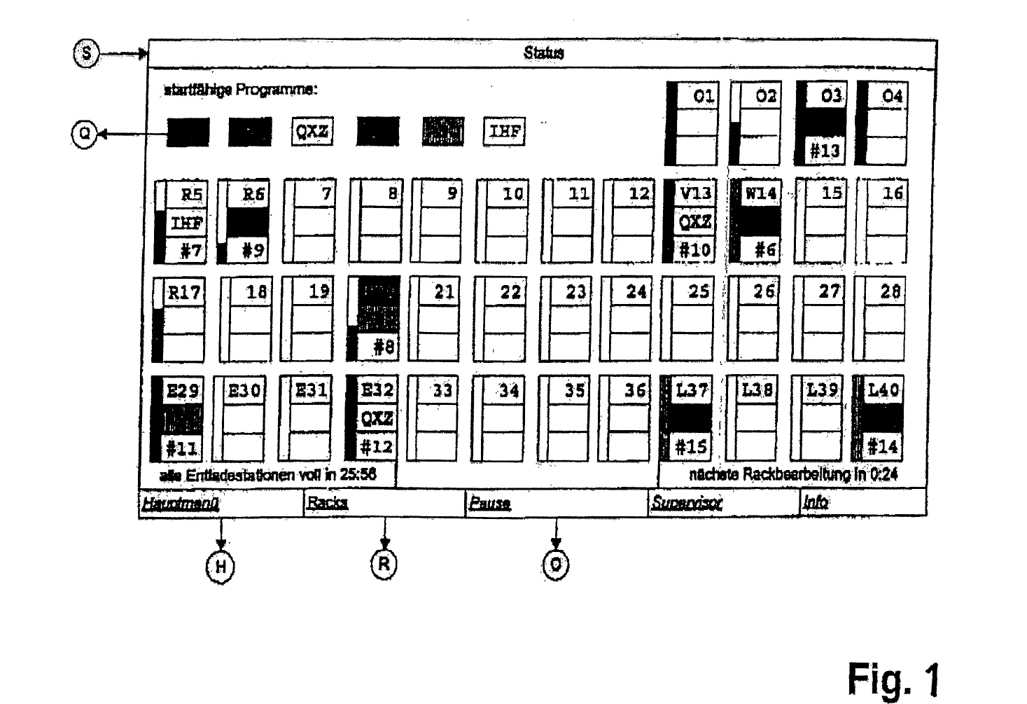

### DETAILED DESCRIPTION OF THE INVENTION

The single Figure shows an exemplary embodiment of a visual indication of the individual processing stations on a display, the arrangement selected therein corresponding approximately to the physical arrangement of the processing stations. Executable staining programs are indicated and are identified in color. The processing stations required by the processing programs can be correspondingly identified, either completely or only partially, in color, so that their association with a processing program is recognizable. It would thus be possible to identify in color only one processing station, namely exactly that processing station that contains a basket. The staining program assigned to the basket would thus be symbolized or illustrated by the color identification.

Additional information is evident from the display; the reader is referred in that regard to the remarks above.

What is claimed is:

1. In a method for treating cytological or histological specimens in an automatic stainer, the specimens being delivered on object carriers and in object carrier magazines by means of a transport device to various processing stations, inserted therein, and treated in accordance with a definable treatment program, the improvement comprising the step of:
unequivocally allocating said object carriers or said object carrier magazines to specific treatment programs.

2. The improvement as defined in claim 1, wherein the allocation is visually perceptible by way of markings.

3. The improvement as defined in claim 2, wherein said markings are provided on clips attached to said object carriers or said object carrier magazines.

4. The improvement as defined in claim 2, wherein said markings are provided on labels attached to said object carriers or said object carrier magazines.

5. The improvement as defined in claim 2, wherein numbers are used as markings.

6. The improvement as defined in claim 2, wherein letters are used as markings.

7. The improvement as defined in claim 2, wherein color codes are used as markings.

8. The improvement as defined in claim 2, further comprising the step of providing a user interface display having symbols representing said treatment programs.

9. The improvement as defined in claim 8, wherein said user interface display further has symbols representing said processing stations.

10. The improvement as defined in claim 9, wherein said processing stations are represented on said display in a manner similar to the physical arrangement of said processing stations and in accordance with how said processing stations are loaded with reagents in said automatic stainer.

11. The improvement as defined in claim 10, further comprising the steps of automatically ascertaining all executable treatment programs and indicating said executable treatment programs on said display.

12. The improvement as defined in claim 11, wherein an execution sequence of said executable treatment programs is evident from said display by allocation of said markings and sequence numbering to said display symbols representing said processing stations

13. The improvement as defined in claim 12, wherein additional information is ascertained and indicated on said display.

14. The improvement as defined in claim 13, wherein said automatic stainer comprises an unloading station for unloading said object carriers or said object carrier magazines, and said additional information includes whether said unloading station is completely filled.

15. The improvement as defined in claim 14, wherein said additional information includes the time remaining until said unloading station will be completely filled.

16. The improvement as defined in claim 13, wherein said automatic stainer comprises a loading station for loading said object carriers or said object carrier magazines, and said additional information includes whether said loading station is completely filled.

17. The improvement as defined in claim 16, wherein said additional information includes the time remaining until the beginning of the next specific treatment program.
